(19) United States
(12) Patent Application Publication
(10) Pub. No.: US 2026/0203261 A1
(43) Pub. Date: Jul. 16, 2026

(54) MULTI-NODAL ARTIFICIAL INTELLIGENCE SYSTEM FOR PROGRESSIVE DATA CLASSIFICATION, ANALYSIS AND PROPRIETARY OUTPUT

(71) Applicant: Razer Technology Solutions, Inc., Wayne, PA (US)

(72) Inventor: Thomas Anderson, Wayne, PA (US)

(73) Assignee: Razer Technology Solutions, Inc., Wayne, PA (US)

(21) Appl. No.: 19/418,847

(22) Filed: Dec. 12, 2025

Related U.S. Application Data
(60) Provisional application No. 63/744,487, filed on Jan. 13, 2025.

(51) Int. Cl. G06F 16/215; G06F 21/60; G06F 21/62

(52) U.S. Cl. CPC G06F 16/215; G06F 21/602; G06F 21/6218

(57) ABSTRACT

An apparatus comprising a plurality of refinement nodes implemented on processors and memory, each arranged as a vertex in a graph topology. Each refinement node obtains inputs, performs refinement operations, and contributes enhanced outputs into a structured interchange maintained in memory accessible across the graph. The structured interchange is realized through embodiments including network-connected data containers, in-memory caches, or distributed key-value stores. Notification mechanisms signal availability of new or modified artifacts through publish-subscribe messaging, polling, processor interrupts, or equivalent signaling techniques. Refinement nodes opportunistically detect and act upon artifacts without centralized orchestration and without requiring synchronization of identical data copies. Refinement operations are cumulative and domain-specific, ensuring no node negates refinements of another. The apparatus operates as a computer-implemented collective system where successive outputs are progressively refined through iterative graph traversal, producing stable, convergent artifacts across diverse application domains.

This application claims priority to Provisional U.S. Patent Application Ser. No. 63/744,487, filed on Jan. 13, 2025, which is incorporated herein as if fully set forth.

### FIELD OF THE INVENTION

A system and method for an advanced multi-node artificial intelligence (AI) system designed to collaboratively process and refine data from both structured and unstructured sources, augmented by user integrations, with repeated and unlimited continuous refinement in real time and producing targeted insights and recommendations in a proprietary output format.

### BACKGROUND

The concept of AI is not new. The formal inception of AI as an academic discipline is largely attributed to a workshop in 1956 where it was the intent to test the assertion that every aspect of learning or any other feature of intelligence can be so precisely described that a machine can be made to simulate it. Since then, machines have become chess champions, replaced many assembly line workers, and generally appear to be capable of many advanced problem-solving endeavors. Computers have become increasingly powerful and through sophisticated algorithms and an underlying large database of information, capable of very useful problem-solving, including data mining, robotics, logistics, speech recognition (and generation), medical diagnosis, and all sorts of search engine capability. With the explosive growth of the Internet and more and more powerful computing power and database storage capacity, accessible higher and higher throughput rates, machine learning programs began to have access to vast amounts of text and images upon from which they could draw conclusions at faster and faster speeds.

The true AI boom however, began perhaps around 2017 through the present through the scaling and development of large language models (LLMs) that increasingly exhibit human-like traits of knowledge, attention and apparent creativity and the public release of LLMs such as ChatGPT. The field of artificial intelligence has advanced significantly in recent years, particularly with the development of LLMs and ensemble-style machine learning systems. These systems demonstrate powerful predictive and analytical capabilities, yet they often operate as monolithic models or in narrowly defined agent frameworks. In practice, such systems may produce useful results, but lack flexibility, adaptability, and structural transparency.

At the same time, several decades of widespread digitization have produced massive volumes of fragmented, inconsistent, and redundant data. While governance frameworks and integration platforms attempt to impose quality through policy and oversight, they often operate as static controls applied after the fact. Such approaches may catalog or restrict data, but they do little to progressively improve its quality. As a result, organizations continue to face unresolved challenges in “data cleanup” at scale, where inconsistent, incomplete, or duplicative artifacts persist despite layers of governance.

Current approaches to distributed AI systems include ensemble methods, workflow automation platforms, and “data fabric” architectures. Ensemble methods combine the outputs of multiple specialized models but typically rely on static routing or central orchestration. Workflow automation systems direct information along prescribed steps, often treating human users as external supervisors or approvers rather than as functional participants in the system. Data fabric architectures focus primarily on connectivity, integration, and governance across heterogeneous sources, but they generally do not provide iterative enhancement of data by autonomous peer nodes.

Comparing LLMs such as ChatGPT and general Internet search engines, one significant difference is that a search engine endeavors to return search results, a list of web pages that will provide a ranked set of results that respond appropriately to the search query. Whereas, the LLM will review the information, parse the queries and produce a result according to a specific set of parameters and established context. The LLM is a dataset of statistically correlated elements and based on those metrics, and has the ability to predict what a human response would most likely be based on the information parsed and craft a response accordingly.

There are several notable patents relating to the development of AI. For example, in U.S. Pat. No. 9,153,142, entitled, User Interface for an Evidence-Based Hypothesis-Generating Decision Support System, issued Oct. 6, 2015, disclosed is, “Systems and methods display at least one subject, and display a location for at least one user to enter at least one problem related to the subject. The problem comprises unknown items to which the user would like more information. In response to the problem, such systems and methods automatically generate evidence topics related to the problem, and automatically generate questions related to the problem and the evidence topics. Further, such systems and methods can receive additional questions from the user. In response to the questions, such systems and methods automatically generate answers to the questions by referring to sources, automatically calculate confidence measures of each of the answers, and then display the questions, the answers, and the confidence measures. When the user identifies one of the answers as a selected answer, such systems and methods display details of the sources and the factors used to generate the selected answer.”

In another example, U.S. Pat. No. 11,308,211 entitled, Security Incident Disposition Predictions Based on Cognitive Evaluation of Security Knowledge Graphs, issued Apr. 19, 2022, discloses, “Mechanisms are provided to perform security incident disposition operations. A security incident is received that includes a security incident data structure comprising metadata describing properties of the security incident, and a corresponding security knowledge graph which includes nodes representing elements associated with the security incident and edges representing relationships between the nodes. The security incident data structure and security knowledge graph are processed to extract a set of security incident features corresponding to the security incident and input the extracted set of security incident features into a trained security incident machine learning model. The model generates a disposition classification output based on results of processing the extracted set of security incident features. The disposition classification output is output to the source of the security incident data structure.”

In another example, U.S. Pat. No. 11,431,660 entitled, System and Method for Collaborative Conversational AI, issued Aug. 30, 2022, “A method for collaborative conversational artificial intelligence (CCAI). The invention discloses an architecture wherein members of the disclosed system participate in collaborative conversations with one or more AI and human “subminds” connected via a forum, including conversing in natural language and facilitated by one or more “facilitators”. CCAI Applications include the creation of widely extensible evolving modular polylogical groups that are capable of collaboration with sentient beings, collaborative control of devices, service worker interfaces, hybrid representations of sentient beings (including via “reconveyance” of conversation segments), in collaborations that may include, exclude or require human or AI participation.”

Thus, there clearly are advancements that attempt to curate information from various and disparate data sets, and involve human input and collaborate to produce output refined even by the reconveyance of information segments. However, just as a human mind processes information input from five distinct senses, processes that information against the vast backdrop of all past experience and teachings in memory, to produce a suggested path or response to the present stimulus, and then refine the response in real-time to the unfolding situation at hand, what is missing from the AI development at present is a system and method that includes multiple AI nodes, each specialized in its specific area (or otherwise specializing in a distinct phase of data processing), operating cooperatively to generate lexical outputs that are transformed into data, which is then further augmented by user input and data integrations. Unlike natural language exchange, which relies on unstructured data, the lexical outputs from these expert nodes may lie anywhere in the spectrum of structured, semi-structured, or unstructured data. This enriched data set enables subsequent levels of analysis by the AI nodes, producing targeted insights and recommended actions. Users can iteratively interact with these outputs, refining inputs that inform and adapt the system's overall processing model. This cyclical refinement process allows for continuous learning and adaptation at each node in the multi-node architecture, resulting in increasingly precise, user-specific actions and analyses. This approach differs from static training of an LLM as it allows for a dynamic “re-training” of the LLM based on human inference in a real-time setting and a continuous review of new datapoints, both structured and unstructured. It also differs from a “chat-context” model in that the refined elements are stored for future refinement and building of the knowledge base creating an ever more specific and “expert” context that is guided by the feedback process.

In our increasingly digitized world, data is generated at an unprecedented rate, with every interaction, transaction, and digital engagement contributing to a continuous flow of data points. As this volume of data grows, the ability of human analysts to make sense of it all becomes severely limited. Conventional visualization tools, such as charts and graphs, can capture only a fraction of the insights buried within these data streams. While these tools may highlight trends or fluctuations, they often lack the crucial context necessary to fully understand the underlying behaviors, intentions, and patterns within the data.

This issue is especially pronounced in realms such as commerce, where data points emerge from diverse sources and reflect complex consumer interactions across multiple channels. For a business, attempting to interpret this fragmented data landscape can lead to incomplete or misleading conclusions. Businesses struggle to constantly understand context and must discern where, when, and how consumers are truly interacting with their offerings. Without the ability to capture and incorporate contextual information, traditional data analysis often falls short, leading to missed opportunities and ineffective strategies.

The challenge, therefore, is to create a system that can move beyond raw data representation to integrate context, enabling a deeper, more comprehensive understanding of consumer behavior and engagement. By doing so, businesses could achieve a richer view of their data, allowing them to respond more effectively and make decisions that are not only data-driven but also contextually informed.

The foregoing approaches share several limitations:
Centralized orchestration—data is routed through fixed pipelines or controlled by a management service, constraining opportunistic behaviors;
Human segregation—Humans are treated as operators or reviewers outside the processing topology, rather than as equivalent contributors, or at least having some sort of hierarchy within the system rather than external;
Static transformation—Outputs are often the result of a single processing pass rather than progressive refinement across multiple traversals;
Strict synchronization requirements—Systems that maintain shared data typically enforce locking or strong consistency, reducing adaptability and scalability;
Limited adaptability—Systems lack the ability to continuously incorporate contextual signals or user corrections to progressively refine outputs (users currently need to ‘start over’ each time they want refined results);
Insufficient cleanup capability—Governance and cataloging approaches may enforce rules, but they do not progressively improve messy or inconsistent data that has accumulated across decades of digitization.

Accordingly, there remains a need for a processor-based system that unifies machine and human contributions, on a pre-defined hierarchical structure, within a shared apparatus, supporting both directed and undirected access to artifacts, and enabling iterative cycles of cumulative refinement that progressively enhance and stabilize outputs without requiring centralized orchestration or strict synchronization of identical copies.

Here, the disclosure overcomes the limitations of prior AI systems and methodologies by introducing a multi-nodal artificial intelligence (AI) system capable of processing both structured and unstructured data through iterative cycles of refinement and unifying machine and human contributions. Through this system, users can wrap context around individual data points and transform fragmented data streams into cohesive narratives. By combining data-driven insights with iterative, user-guided refinement, this system bridges the gap between raw data and actionable insights, allowing users to not only visualize data but also understand and act on it in a meaningful way.

### SUMMARY

The present disclosure relates to a multi-nodal artificial intelligence (AI) system designed to perform iterative data transformation and analysis through a progressive feedback cycle. The system is structured as a loosely coupled network of cooperating AI nodes, each configured to specialize in different aspects of data processing and analysis. By leveraging both structured and unstructured data inputs, the system can produce progressively refined insights that evolve based on a continuous loop of data generation, transformation, user interaction, and re-analysis.

The present disclosure provides an apparatus for collective and iterative data enhancement. In one embodiment, the apparatus comprises a plurality of refinement nodes arranged as vertices in a graph topology and implemented on processors and memory storage areas. Each refinement node is configured to receive one or more inputs, perform a refinement operation, and emit enhanced outputs via a structured interchange protocol and maintained in memory-accessible across the graph. The structured interchange may be realized through multiple mechanisms, including but not limited to: (i) a network-connected data container, (ii) an in-memory cache, and/or (iii) a distributed key-value store. From the perspective of the apparatus, all refinement nodes access the same structured interchange, regardless of implementation. A notification mechanism or functional indications under the structured interchange protocol signal the availability of new or modified artifacts, enabling nodes to act without orchestration. Indications may be implemented through publish/subscribe events, polling cycles, processor interrupts, or shared flags, among other mechanisms. Refinement operations are independent, asynchronous, and domain-specific. Each node may only modify aspects of an artifact within its assigned domain (authorized scope), ensuring that refinements are non-reversible with respect to one another. This prevents thrash or undoing of progress. Convergence arises as more domains are refined, progressively filling in incomplete artifacts until they stabilize into a more complete and consistent state.

### BRIEF DESCRIPTION OF THE DRAWINGS

FIG. 1 depicts one embodiment of a graph topology configuration of the apparatus, comprising a plurality of refinement nodes represented as vertices. Both artificial intelligence modules and human participants represented through compute interfaces are depicted as nodes within the graph. A structured interchange protocol, which may be realized through a network-connected data container, in-memory cache, or distributed key-value store, is conceptually shown as the medium through which artifacts are stored and accessed. Indications of availability, which may be implemented through publish/subscribe events, polling, interrupts, or shared flags, enable nodes to opportunistically retrieve and enhance artifacts without centralized orchestration.

FIG. 2 depicts one embodiment of a linear sub-graph arrangement of the apparatus. Refinement nodes are arranged in a path graph resembling an assembly line. Each node retrieves artifacts from the structured interchange, performs a refinement within its domain, and writes updated artifacts back for subsequent nodes to access in sequence.

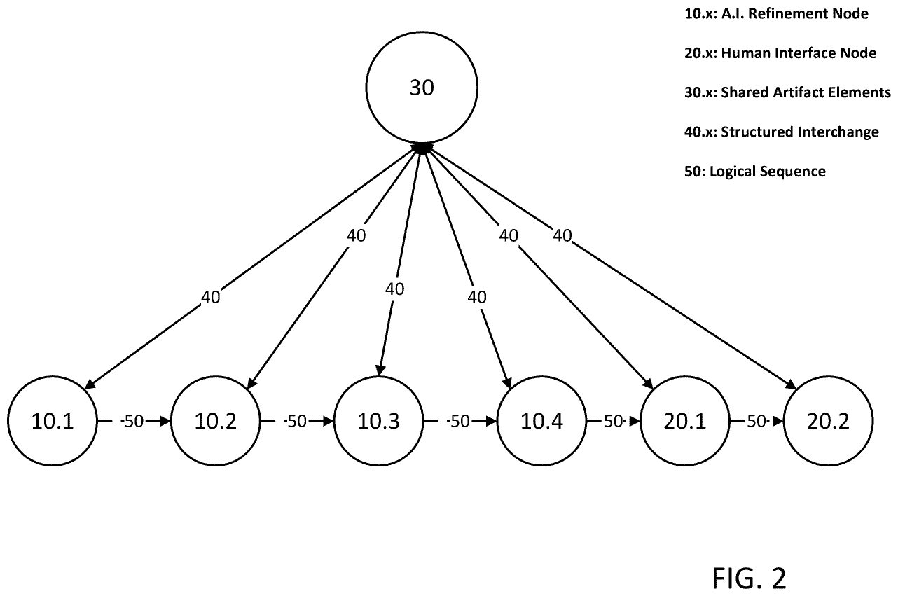

FIG. 3 depicts one embodiment of a circular sub-graph arrangement of the apparatus. Refinement nodes are arranged in a cycle graph, with artifacts repeatedly written into and retrieved from the structured interchange. This embodiment supports circular refinement loops across repeated traversals, with indications of availability when updated artifacts become available for further enhancement.

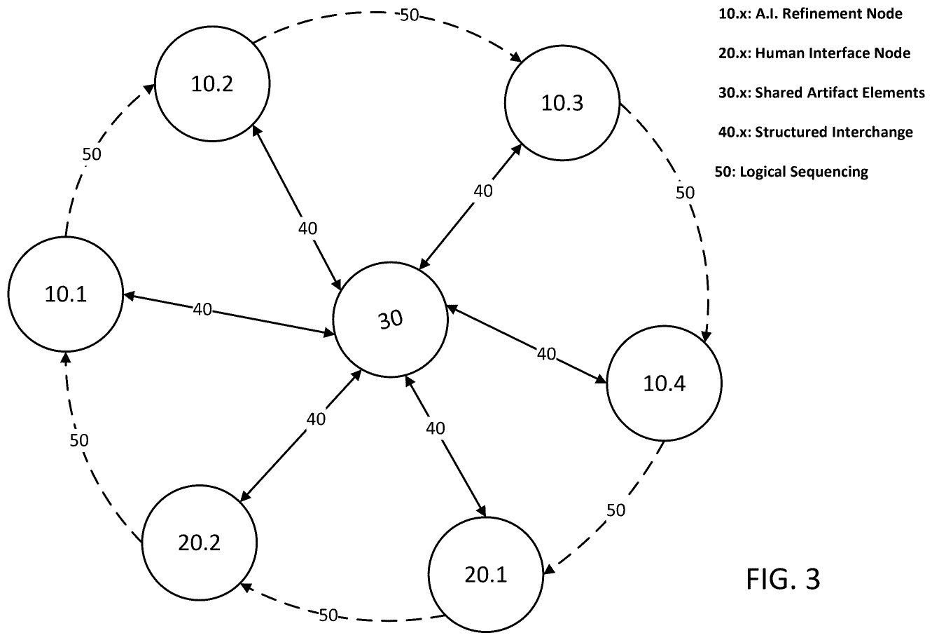

FIG. 4 depicts one embodiment of a workflow in which traversal order through the graph is employed as a control mechanism. A prescribed sequence of nodes is highlighted, demonstrating that only artifacts refined along that sequence within the structured interchange produce a valid or interpretable output. Alternative access patterns result in incomplete or restricted outputs.

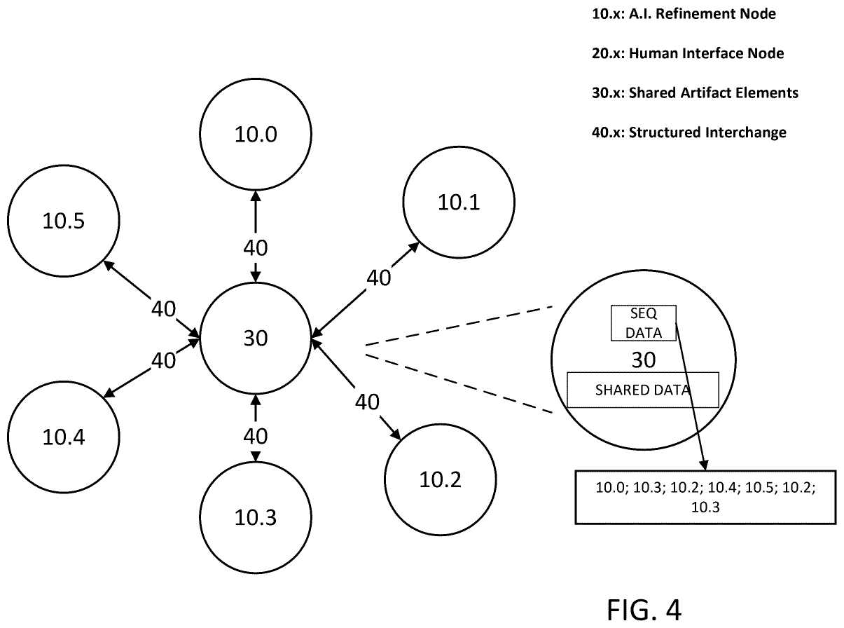

FIG. 5 depicts one embodiment of a human participant represented as a compute interface node. The node retrieves data artifacts, incorporates human-provided input (e.g., annotation, authentication, or contextual data), and writes an enhanced artifact back into the interchange for access by other nodes.

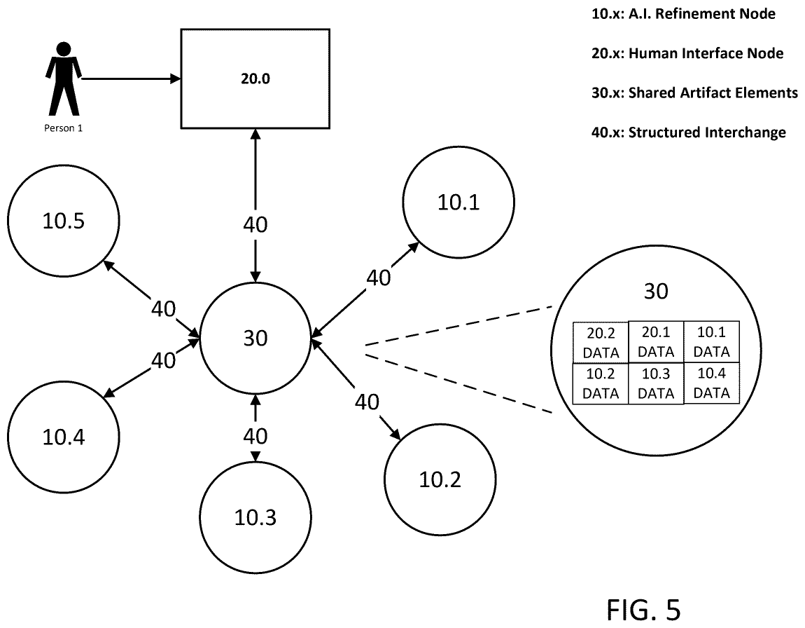

FIG. 6 depicts one embodiment of an undirected, opportunistic refinement process. Data artifacts are shown as entries within the structured interchange, with multiple refinement nodes independently detecting, enhancing, and reintroducing them. Indications are depicted as lightweight signals of availability, enabling opportunistic refinement without predetermined routing.

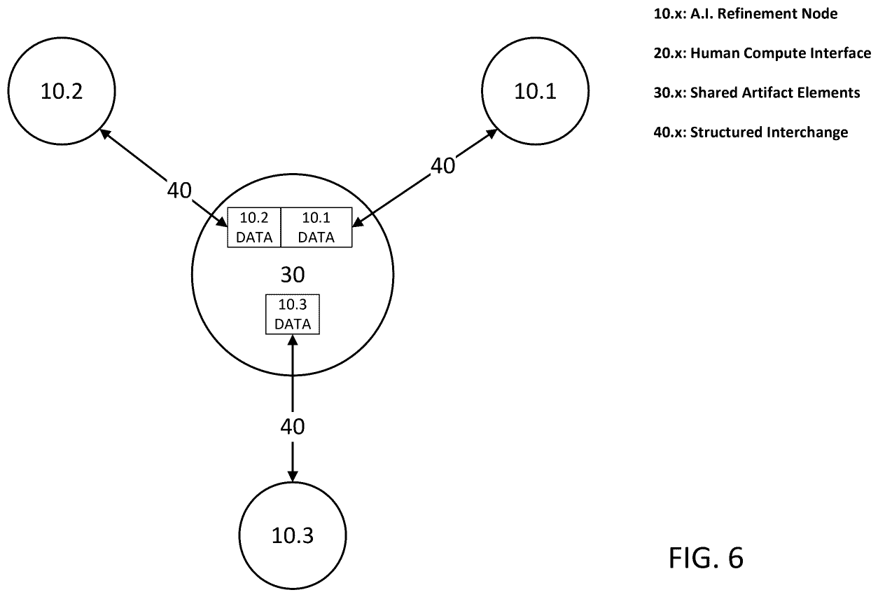

### DEFINITIONS

As used herein, a ‘refinement node’ refers to a logical unit (which could implement human input) implemented on processors and memory that operates as a vertex in a graph topology, wherein each node is configured to: (i) retrieve data artifacts from a structured interchange, (ii) perform domain-specific processing operations within an assigned authorized scope, and (iii) make enhancements available back to the structured interchange, without requiring centralized orchestration or negating refinements from other nodes.

As used herein, a ‘data artifact’ refers to a discrete unit of information comprising structured, semi-structured, and/or unstructured data elements that can be processed or modified by refinement nodes. Data artifacts may include, but are not limited to, customer records, loan applications, security incident reports, medical diagnoses, digital media, images, audio, or any composite data structure containing at least one attribute or domain that can be independently modified and progressively enhanced through iterative processing.

As used herein, a ‘structured interchange’ refers to a persistent, memory-accessible storage medium that serves as a shared communication and data repository among refinement nodes in the graph topology. The structured interchange maintains data artifacts in a format accessible to all authorized refinement nodes, supports mechanisms for signaling data artifact availability, and enables asynchronous, independent access without requiring strict synchronization of identical copies among nodes. Implementation may include network-connected data containers, in-memory caches, distributed key-value stores, or equivalent memory-based structures.

As used herein, an ‘authorized domain’ refers to a predefined subset of attributes, fields, and/or elements within a data artifact that a specific refinement node is permitted to modify. Domain scoping controls ensure that each refinement node can only access and modify data elements within its assigned authorized domain, preventing interference with refinements made by other nodes and ensuring cumulative, non-conflicting enhancements.

As used herein, ‘cumulative and non-negating’ refinements refer to data enhancement operations where each refinement node adds to or enhances existing data elements without overwriting or contradicting refinements previously contributed by other nodes, thereby ensuring that all valid refinements are preserved and integrated into progressively more complete data artifacts.

As used herein, ‘graph topology’ refers to the structural arrangement of refinement nodes as vertices connected by the structured interchange to support the data flow relationships, wherein the topology may comprise linear paths, circular cycles, undirected meshes, or hybrid configurations.

As used herein, ‘centralized orchestration’ refers to system architectures that rely on a central controller or management service to direct, sequence, and coordinate data processing operations among distributed components, in contrast to this disclosure's approach of independent, opportunistic node operation.

As used herein, ‘successive graph traversals’ refers to repeated cycles wherein data artifacts are processed through a plurality of refinement nodes across the graph topology, with each traversal potentially involving the same or different refinement nodes acting on progressively enhanced versions of data until convergence is achieved.

As used herein, ‘convergence’ refers to a state achieved when data artifacts reach pre-defined measures of stability, which may be different for each data artifact, through iterative refinement, wherein successive graph traversals produce progressively diminishing modifications to the artifacts until additional refinements result in minimal or no further enhancement of completeness, consistency, or quality within the authorized domains of the refinement nodes. It will be appreciated by one of skill in the art that for any specific data artifact, convergence is considered achieved when: (i) all authorized domains within a data artifact have been processed by their assigned and available refinement nodes, (ii) subsequent traversals produce modifications below a predetermined threshold for that specific data artifact, wherein such predetermined thresholds may be defined based on factors including data artifact type, domain criticality, or system performance requirements, and (iii) no further refinement nodes signal availability of further enhancements for that data artifact, each one of the foregoing conditions, to the extent available and applicable.

### DETAILED DESCRIPTION

For clarity of disclosure, and not by way of limitation, the detailed description of the invention is divided into the following subsections that describe or illustrate certain features, embodiments or applications of the present invention.

### The System and Method of the Present Invention

In one embodiment, the core of this system is embodied in a multi-nodal architecture, comprising a network of interconnected AI nodes. Each node operates autonomously but communicates with other nodes to achieve collective analytical goals. Nodes are configured with distinct roles based on the type of data they process or the stage of analysis they handle. For example, some nodes specialize in extracting insights from unstructured data, such as text, while others are optimized for structured data analysis, such as numerical metrics. Other nodes specialize at turning lexical elements into data points to further refine and classify the ontology of the learning model. This cooperative, multi-node arrangement allows the system to analyze data at a granular level while coordinating higher level transformations to produce holistic insights.

In one embodiment, the invention is embodied as an apparatus comprising a plurality of refinement nodes interconnected in a graph topology and implemented on processors and memory. Each refinement node is represented as a vertex within the graph and is configured to obtain artifacts, perform refinement operations, and contribute enhanced outputs via a structured interchange maintained in memory.

In one embodiment, the structured interchange may be realized through a variety of mechanisms, including but not limited to: a network-connected data container, an in-memory cache such as a hashmap, or a distributed key-value store or similar mechanisms. Regardless of implementation, the structured interchange provides a persistent medium through which artifacts are accessible to all refinement nodes.

In one embodiment, the apparatus obtains functional indications that new or modified artifacts are available via the structured interchange. Indications may be implemented through publish/subscribe messaging, polling, processor interrupts, shared flags, or equivalent signaling techniques; they merely indicate availability and do not perform orchestration or enforce sequencing of node behavior.

In one embodiment, each refinement node operates independently and may refine artifacts without coordination with other nodes. At the same time, refinement nodes may opportunistically take advantage of prior refinements committed via the structured interchange. By combining independence with opportunistic advantage, the apparatus supports iterative, progressive refinement cycles that yield increasingly complete and stable artifacts across successive traversals of the graph.

In one embodiment, each refinement node is represented as a vertex within the graph topology and is implemented on processors and memory. Refinement nodes may include artificial intelligence modules, human participants represented through logical units, or traditional computing processes. From the perspective of the apparatus, all refinement nodes are functionally indistinguishable in their participation: each obtains artifacts, applies a refinement, and contributes results via the structured interchange.

In one embodiment, each refinement node may be assigned a domain of responsibility within an artifact (authorized scope). Node fencing ensures that refinements are cumulative and domain-specific: a refinement node may only modify data elements within its designated domain and does not alter refinements contributed by other nodes. For example, a node may enrich contextual metadata but cannot overwrite a classification value produced by another node. In another embodiment, specialization arises from the design of the nodes, such as nodes dedicated to processing structured data, unstructured text, or lexical-to-data conversion.

In one embodiment, refinement nodes may implement different categories of refinement operations, including but not limited to: Annotation (adding explanatory or descriptive labels), Classification (assigning numeric or categorical values), Contextual enrichment (attaching related data or metadata), Transformation (converting data from one form to another), and Deletion or pruning (marking irrelevant or redundant elements). Refinements are cumulative, such that each addition augments the state of the artifact without negating earlier contributions. In some embodiments, refinement nodes adapt their operations based on prior refinements.

In one embodiment, human refinement nodes operate through logical units such as terminals, mobile devices, or voice-driven systems. These nodes may contribute refinements such as annotation, correction, validation, or contextual input. Human refinements are stored via the structured interchange identically to machine refinements, ensuring that all contributions are processed cumulatively.

In one embodiment, the apparatus includes a structured interchange through which data artifacts are persistently accessible to all refinement nodes. The interchange may be realized through multiple mechanisms, including but not limited to:
a network-connected data container accessible by refinement nodes over a communication link;
a publish-subscribe mechanism interconnecting nodes and data artifacts;
an in-memory cache such as a hashmap or equivalent data structure;
a distributed key-value store such as Redis (used here to denote an in-memory data structure store, used as a database, cache, and message broker or quick-response database) or similar systems.

In one embodiment, the structured interchange encompasses any memory-based structure, whether local or distributed, that enables refinement nodes to store enhanced artifacts and retrieve previously refined artifacts. The interchange is maintained on processors and memory and is accessible to refinement nodes operating within the apparatus.

In one embodiment, a functional indication mechanism signals the availability of new or modified artifacts within the structured interchange. Indications may be realized through publish/subscribe messaging, polling intervals, processor interrupts, shared state flags, or equivalent signaling techniques. The indications do not perform orchestration or sequencing of refinement node behavior; they merely provide signals that updated artifacts are available for potential refinement.

In one embodiment, refinement nodes act independently and may opportunistically detect available artifacts through such indications. In one embodiment, indications are directed such that artifacts are refined in a prescribed sequence of nodes. In another embodiment, indications are undirected, and refinement nodes retrieve artifacts opportunistically without predetermined routing. Because artifacts persist in the structured interchange, strict synchronization of identical copies among refinement nodes is not required. Independence of refinement nodes is preserved, while convergence arises naturally from accumulation of refinements across successive traversals.

In one embodiment, iterative refinement in the disclosed apparatus is defined as cumulative, non-negating refinement: each refinement node may enhance an artifact without requiring coordination with other nodes, and without undoing contributions already made. Because refinements are applied within the scope of each node's authorized domain, new information is incorporated additively while prior refinements are preserved.

In one embodiment, across successive traversals of the graph, artifacts progressively converge toward more complete and consistent states. Each traversal may add annotations, contextual information, classifications, or transformations relevant to a given domain. As these refinements accumulate, artifacts stabilize in quality and content, reducing gaps and inconsistencies. The process can be likened to improving the resolution of an image: an artifact with sparse refinements may appear incomplete or coarse, while successive refinements progressively sharpen the artifact into a more comprehensive state.

In one embodiment, convergence is achieved because refinements are cumulative and scoped, rather than globally overwriting. A refinement node may enrich contextual metadata, but it does not alter classification values contributed by another node. In another embodiment, merge rules are defined for each domain to ensure that refinements are incorporated consistently. For example, symbolic annotations may be combined into a collective set, numerical scores may be updated by selecting the most confident value, and contextual metadata may be accumulated alongside existing attributes.

In one embodiment, these merge rules are not limited to a single implementation. In some embodiments, they may include comparison-based selection (e.g., keeping the maximum of two scores), accumulation of symbolic labels, or simple additive updates. In other embodiments, refinements are accepted as additional entries without modification of prior contributions. In all cases, the defining characteristic is that refinements build upon prior contributions without negating them.

In one embodiment, because refinements are cumulative and do not require global locks or centralized consensus, nodes operate independently yet opportunistically. A refinement node can take advantage of prior refinements already stored via the structured interchange and extend them further. Over time, as more nodes contribute to more domains, artifacts converge naturally into stable, consistent representations without reliance on strong synchronization or centralized orchestration.

In one embodiment, refinement nodes implemented on processors and memory are arranged in a linear path graph. Each node retrieves artifacts via the structured interchange, performs domain-specific refinements, and contributes updated artifacts back. Indications may be directed such that artifacts pass sequentially through the prescribed nodes, resembling deterministic assembly-line processing (for example and without limitation, in document review workflows.)

In another embodiment, refinement nodes are arranged in a cycle graph. Artifacts produced by downstream nodes are reintroduced to upstream nodes via the structured interchange, enabling circular refinement loops. Indications of updated artifacts may trigger repeated traversal until sufficient refinements accumulate to stabilize the output (for example and without limitation, in iterative model tuning.)

In yet another embodiment, refinement nodes operate in an undirected mesh configuration. Nodes do not follow predetermined traversal paths, but instead opportunistically detect artifacts signaled as available, apply domain-specific refinements, and contribute results back. Because refinements are cumulative and fenced to node-specific domains, no two nodes can overwrite or negate each other's contributions. Temporary duplication or overlap of refinements may occur (e.g., multiple annotations), but such duplication does not destabilize the apparatus. Across successive traversals, refinements accumulate, progressively filling incomplete attributes until artifacts converge into stable, more complete representations (for example and without limitation, in enterprise data cleanup).

In some embodiments, traversal order through the graph is employed as a constraint. Only artifacts refined through a prescribed sequence of refinement nodes are deemed valid or authorized. Alternative traversal orders may result in incomplete or restricted outputs. This provides a mechanism for secure, role-based, or context-sensitive access control without reliance on cryptographic primitives (for example and without limitation, in a healthcare review path).

In one embodiment, each node can produce lexical outputs—segments of processed information derived from raw data inputs. These outputs may include patterns, trends, or key insights identified by the node's specific processing algorithms. Nodes share their outputs with one another, facilitating a distributed form of analysis that builds on each node's specialty. Lexical outputs can be produced as either text or raw data in the form of numerical data points.

In one embodiment, the system's architecture supports a self-sustaining cycle in which data and insights generated by one node can be reintroduced as input into other nodes, or back into the same node, for further transformation. This “round-trip” cycle allows the system to iteratively refine its analyses by continuously incorporating its own outputs as inputs, along with new user provided data. This technique permits the creation of multiple pathways that establish sub-context specific to each of the expert nodes allowing for a more specific refinement of the overall result.

In one embodiment, a typical cycle begins with initial raw data, which is processed by nodes according to their designated functions. The processed data is then transformed into actionable insights and recommendations by the system. These insights may be visualized, summarized, or otherwise presented in a form that prompts user feedback or additional input. User responses and interactions provide supplementary data points, which are fed back into the system as new inputs, enabling the cycle to begin anew with an enriched data set.

In one embodiment, an integral feature of the system and method disclosed herein, is its ability to incorporate user interaction within each cycle. Users interact with the system by providing input based on the insights or recommendations generated by previous cycles. This input may include user data, additional contextual information, or specific feedback on the generated insights. The system ingests these user inputs and combines them with internally generated data, creating a dynamic interplay between user provided and system generated information.

In one embodiment, by assimilating user data and feedback, the system refines its analytical models and adapts its processing strategies, progressively improving the relevance and accuracy of subsequent insights. This iterative, user-guided refinement process not only enhances the analytical depth of each cycle but also allows the system to evolve in alignment with the user's goals and preferences.

In one embodiment, through multiple cycles of transformation and analysis, the system produces increasingly precise outputs, which may include insights, recommendations, and user-specific actions. Each new cycle leverages the cumulative effect of prior analyses, creating a progressive feedback mechanism. This allows the system to adapt dynamically to changes in data or user behavior, leading to insights that reflect the most current and relevant information available.

In one embodiment, an initial cycle might provide a broad analysis based on general data trends, while subsequent cycles, enriched by specific user inputs, produce targeted recommendations and action items. These outputs may be tailored to particular use cases, such as optimizing customer engagement strategies, identifying patterns in consumer behavior, or fine tuning marketing initiatives.

In one embodiment, the inter-nodal relationships within this system are essential to its operation. Each AI node exchanges data with others through a structured interchange protocol, which allows for real-time synchronization of data insights across nodes. This interchange protocol is abstracted to handle diverse data types, ensuring that both structured (numerical, categorical) and unstructured (textual, visual) data can flow seamlessly between nodes.

In one embodiment, these interconnections allow the system to balance computational loads across nodes, optimizing processing efficiency, and achieving higher levels of analytical precision. The nodes continuously adjust their processing in response to insights shared by others, ensuring that each node's output is informed by the broader system context.

In one embodiment, this architecture is designed to be adaptive and resilient to variations in data input, processing demands, and user interactions. Technical safeguards ensure that each node's data transformations are aligned with the overall analytical objectives, while the system dynamically reallocates resources across nodes based on processing requirements. This adaptive capability allows the system to scale in response to data volume and user engagement levels, while maintaining a high degree of analytical precision.

In one embodiment, this system is also designed to support a modular configuration, allowing individual nodes, or sets of nodes, to be added, removed, or reconfigured without disrupting the overall workflow. This flexibility ensures that the system as disclosed herein can be tailored to different application contexts, industries, or analytical needs without requiring fundamental changes to its architecture.

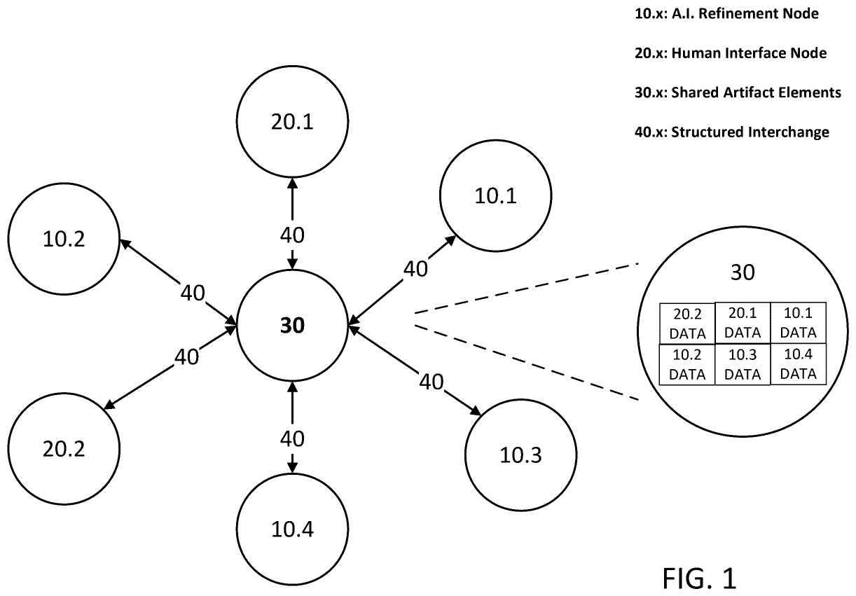

Referring to FIG. 1, one embodiment of the system and architecture as described herein demonstrates a potential arrangement of AI Nodes, the processing flow of data with inputs and outputs and user interactions, the reprocessing of such data with refinements, and the implementation of output in accordance with the foregoing description.

### EXAMPLES

The present invention is further illustrated, but not limited by, the following examples.

In one embodiment, a company may want to analyze past and predict future behavior of its customers. Such behavior may be influenced by many complex outside stimuli, such as customer wants and needs, time of year, pricing, marketing, social media influencing, and the like. Historically, focus groups and other traditional advertising company research has been used to quantify and qualify customer behavior. Companies now, though, may internalize the process and would need to, as part of the analytics process, gather and analyze all appropriate business context, including business goals, marketing plans, and prior year data. Use of a simple LLM may bring to bear use of predictive analytics to forecast future buying behaviors based on historical data.

In this embodiment, though, simple historical data may not be sufficient to give an accurate picture. A data scientist in the company may want to model lifetime value for different segments to focus on profitability. This would require taking existing data points and properly classifying them based on ontological context. Customer interaction patterns could dictate certain churn risks.

In an embodiment, this company could use multiple LLMs to aggregate and interpret complex customer data sets, converting them into coherent story based reports that clearly narrate an individual customer's journey and potential future paths. An ability to input specific customer journey metrics into various LLMs to generate predictions and stories about customer behavior, highlighting key moments and opportunities for engagement would be needed. Various LLM based tools could translate data from customer feedback, social media interactions, and support tickets, into narratives. The LLMs would identify patterns and trends from customer data and translate these findings into actionable marketing and product development stories, allowing non-technical team members to make data-driven decisions. The integration of the LLM tools could process and interpret cross-channel analytics, providing a synthesized story that integrates customer behaviors across platforms and touchpoints, offering a unified view of the customer experience.

In one embodiment, in the finance world, the apparatus is applied to credit evaluation workflows. Refinement nodes include machine learning modules that calculate credit scores, fraud detection modules that assess risk, and human analysts that validate exceptions. Each node contributes refinements to a shared object space representing a loan applicant's profile. A scoring node may contribute a baseline credit score. A fraud detection node may add anomaly flags or transaction patterns. A human analyst node may annotate inconsistencies in employment history. Refinements are cumulative, ensuring that no node overwrites another's contribution. Across successive traversals, the applicant profile stabilizes into a progressively more complete risk assessment.

In another embodiment, in the manufacturing world, the apparatus is applied to quality assurance in manufacturing processes. Refinement nodes represent different inspection and monitoring stages. A vision system node inspects parts for defects. A sensor node records dimensional measurements. A human quality inspector node annotates borderline cases requiring review. Each refinement accumulates in the shared object space for the product batch. Over multiple traversals, artifacts converge toward a comprehensive quality record, combining sensor data, automated inspection, and human judgment. This cumulative refinement enables early defect detection and continuous improvement of production processes.

In another embodiment, in the security world, the apparatus is applied to security and threat detection. Refinement nodes include intrusion detection systems, anomaly detectors, and human security analysts. An automated intrusion detection node may flag suspicious IP addresses. An anomaly detection node may contribute unusual traffic patterns. A human analyst node may validate threats and add contextual intelligence. All contributions accumulate in the shared object space representing system activity. Refinements are cumulative and domain-specific, ensuring that multiple detection systems cannot negate each other's findings. Across traversals, the artifact converges into a consolidated security incident record that integrates machine and human perspectives.

In another embodiment, in the healthcare environment, the apparatus is applied to collaborative healthcare decision support. Refinement nodes include diagnostic models, peer-review modules, and human clinicians. A diagnostic AI node may generate a preliminary finding based on medical images. A peer-review node may add comparative analysis against historical cases. A human clinician node may annotate relevant patient history or contextual factors. Each refinement accumulates in the shared object space representing the patient record. Because refinements are cumulative, diagnostic suggestions are progressively enhanced, integrating machine predictions, peer review, and clinical expertise. Over successive traversals, the record converges into a more accurate and comprehensive treatment recommendation.

In another embodiment, the apparatus is applied to enterprise data management. Over decades of digitization, organizations often accumulate inconsistent and redundant records. Refinement nodes independently contribute cleanup refinements:
A normalization node standardizes formats (e.g., phone numbers, addresses);
A deduplication node merges duplicate customer records;
A human data steward node validates corrections and fills missing identifiers.

Because refinements are cumulative, records progressively improve with each traversal. Over successive passes, inconsistent artifacts converge into stable, clean, and authoritative records that governance frameworks alone could not achieve.

The foregoing examples are provided to illustrate the range of applications for the disclosed apparatus and are not intended to limit the scope of the invention. The cumulative refinement mesh described herein may be applied across numerous domains in addition to finance, manufacturing, security, enterprise data cleanup, and healthcare, including but not limited to education, logistics, commerce, and government systems. In all such embodiments, the apparatus enables independent refinement nodes to contribute cumulative, domain-specific enhancements into a shared object space, producing progressively convergent artifacts without centralized orchestration or strict synchronization requirements.

The foregoing disclosure describes many embodiments of an apparatus that delivers concrete technical advantages over conventional workflow engines, centralized orchestrators, ETL pipelines, and strongly synchronized distributed stores. These advantages arise from the combination of a structured interchange maintained in memory, domain-scoped integrity controls, availability-based activation, and graph-based node participation with human and machine parity.

In one embodiment, refinement nodes operate based on interchange indications of availability or modification rather than a central scheduler. This reduces coordination latency while preserving correctness through domain-scoped contributions. Unlike traditional orchestrators that impose serialized choke points, the apparatus enables opportunistic concurrency and higher utilization of compute resources.

In one embodiment, each refinement node is constrained to its authorized domain. This prevents cross-domain overwrites and reduces “thrash” common in systems where multiple actors compete for the same fields. By fencing changes to specific attribute groups, progress is additive and prior refinements are preserved.

In one embodiment, because refinements accumulate rather than negate one another, artifacts converge over successive traversals. Nodes naturally take advantage of prior refinements already persisted via the interchange. Unlike single-pass pipelines, this supports iterative sharpening of outputs until additional passes produce little or no further change

In one embodiment, the apparatus supports path (linear) sequences for deterministic flows, cycle graphs for repeated tuning loops, and undirected meshes for opportunistic refinement. Prior approaches typically hard-code one mode (e.g., assembly-line workflow); here, the topology itself provides flexibility without redesigning the compute units.

In one embodiment, human contributions such as annotation, validation, or contextual input enter through compute-interface nodes and are stored identically to machine refinements. This yields traceable, in-band human signal that subsequent nodes can exploit—unlike traditional “human-in-the-loop” systems that keep human actions out-of-band or as post-hoc approvals.

In one embodiment, by localizing writes to domain-scoped attribute sets and avoiding global locks, the apparatus reduces contention. Traditional solutions rely on coarse locking or last-writer-wins heuristics that discard useful information. Here, scoped updates allow more simultaneous progress across independent domains of the same artifact.

In one embodiment, the structured interchange can be realized as a shared data structure in memory, a network-connected container, or a distributed store. This plurality of embodiments avoids binding correctness to a single storage technology and allows deployment from single-host to distributed backplanes without altering node logic.

In some embodiments, merge rules are designed so that refinements produce consistent outcomes regardless of the sequence in which they are applied. This reduces sensitivity to timing or order of delivery and helps ensure stable convergence under concurrency, without requiring strong global synchronization.

In one embodiment, because nodes are loosely coupled through the interchange, individual node failure or temporary unavailability does not stall the system. Artifacts remain available for other nodes, and the failed node can resume work on new indications when restored. Traditional orchestrators frequently propagate a single failure into pipeline-wide backpressure.

In one embodiment, new refinement nodes can join the graph by subscribing to indications relevant to their authorized scopes; existing nodes require no changes. In contrast, centrally orchestrated pipelines demand controller updates and redeployments for every route change. Here, capabilities accrete with minimal disruption.

In one embodiment, event-driven activation avoids waiting for batch windows or global checkpoints. As soon as a relevant change is surfaced under the interchange, a capable node can act, shortening latency to refined output compared to periodic, centrally scheduled passes.

The foregoing disclosure addresses limitations of prior distributed AI and workflow systems by providing a processor-based apparatus of refinement nodes that interact via a structured interchange maintained in memory (shared object space embodiment). Human participants and artificial intelligence modules are represented equivalently, or at least independently, as refinement nodes, each contributing cumulative refinements. By eliminating the need for centralized orchestration or strict synchronization of identical copies, the apparatus enables independent operation with opportunistic advantage. Traversal order may further serve as a control mechanism. Unlike governance or cataloging frameworks that merely impose oversight rules, the apparatus functions as a cumulative refinement mesh capable of progressively improving fragmented, inconsistent, or redundant digital artifacts.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. An apparatus for collective and iterative data enhancement, comprising:
(a) a structured interchange maintained in memory-accessible storage and accessible to a plurality of refinement nodes, the structured interchange configured to persistently store data artifacts without requiring strict synchronization of identical copies among the refinement nodes;
(b) the plurality of refinement nodes implemented on one or more processors and memory and arranged as vertices in a graph topology, each refinement node being assigned an authorized domain within data artifacts and configured to:
(i) receive, via a mechanism for signaling data artifact availability, an indication of availability of a data artifact for refinement within the node's authorized domain;
(ii) retrieve the data artifact from the structured interchange;
(iii) perform a domain-specific refinement operation that modifies the data artifact within the node's authorized domain without negating refinements contributed by other refinement nodes;
and
(iv) provide the enhanced data artifact back to the structured interchange;
(c) domain scoping controls configured to restrict each refinement node to modify only data elements within its assigned authorized domain,
and
(d) the mechanism for signaling data artifact availability implemented through the structured interchange and configured to actively signal availability of new or modified data artifacts through at least one of: publish-subscribe messaging, polling cycles, processor interrupts, and shared state flags; and
wherein the refinement nodes operate independently without centralized orchestration, wherein refinements are cumulative and non-negating and wherein data artifacts progressively converge toward more complete and consistent states through successive graph traversals.

2. The apparatus of claim 1, wherein at least one of the plurality of refinement nodes comprises a logical unit node that receives human input and wherein said human input, if present, is treated as a potential data artifact modification applying the same process as for machine generated refinements.

3. The apparatus of claim 1, wherein data artifacts comprise pre-defined typed attribute groups and domain identifiers mapping attributes to specific domains.

4. The apparatus of claim 1, wherein the structured interchange maintains, for each data artifact and for each specific domain, version metadata comprising vector timestamps or equivalent causality markers to support independent reapplication and deduplication of refinements.

5. The apparatus of claim 1, wherein the graph topology is non-hierarchical and comprises directed and undirected edges corresponding to explicit subscriptions or implicit availability relationships among nodes.

6. The apparatus of claim 1, wherein the graph topology comprises a cycle subgraph enabling data artifacts to be reintroduced for repeated modification across a plurality of traversals.

7. The apparatus of claim 1, wherein the graph topology comprises an undirected mesh enabling refinement nodes to opportunistically detect or receive active notification of available data artifacts and perform modifications without predetermined routing.

8. An apparatus for traversal-based access control of data artifacts, comprising:
(a) a structured interchange maintained in memory-accessible storage and accessible to a plurality of refinement nodes, the structured interchange configured to persistently store data artifacts without requiring strict synchronization of identical copies among the refinement nodes;
(b) the plurality of refinement nodes implemented on one or more processors and memory and arranged as vertices in a graph topology, each refinement node being assigned an authorized domain within data artifacts and configured to:
(i) retrieve a data artifact from the structured interchange;
(ii) apply a node-specific transformation to a designated portion of the data artifact;
(iii) record within the data artifact an indication of the node's position in a traversal sequence; and
(iv) store the modified data artifact back to the structured interchange;
(c) a mechanism for signaling data artifact availability configured to signal availability of data artifacts for processing; and
(d) traversal validation logic configured to determine validity or accessibility of a data artifact based on whether the artifact has been processed through a prescribed sequence of refinement nodes,
wherein only data artifacts that have traversed the prescribed sequence of refinement nodes are deemed valid or interpretable by the apparatus.

9. The apparatus of claim 8 wherein each refinement node encrypts or transforms a different portion of a data artifact according to a node specific pre-defined algorithm.

10. The apparatus of claim 8 wherein a data artifact comprises a composite data structure in which sub-elements are independently encrypted by successive refinement nodes.

11. The apparatus of claim 8 wherein the traversal sequence of data artifacts through refinement nodes is configured to function as a decryption key, enabling valid interpretation only when the sequence of refinements is reproduced.

12. The apparatus of claim 8 wherein the traversal order of data artifacts through refinement nodes is determined opportunistically based on which refinement node first detects a specific data artifact, such that the sequence of refinements cannot be predicted in advance.

13. The apparatus of claim 8 wherein attempts to access a data artifact without the correct traversal sequence results in unintelligible output.
